(19) United States
(12) Patent Application Publication
(10) Pub. No.: US 2004/0243841 A1
(43) Pub. Date: Dec. 2, 2004

(54) Network configuration using scannable token

(76) Inventors: Bradley W. Stumpf, Arlington, TX (US); Billy Joe Steiger JR., Orvilla, TX (US)

Correspondence Address: Stuart R. Hemphill, DORSEY & WHITNEY LLP, Intellectual Property Department, 50 South Sixth Street, Suite 1500, Minneapolis, MN, 55402-1498, US

(21) Appl. No.: 10/452,525

(22) Filed: Jun. 2, 2003

(51) Int. Cl. H04L 9/00

(52) U.S. Cl. 713/201

(57) ABSTRACT

A method and apparatus for enabling a network device to communicate to a host computer in a communications network is provided. The apparatus includes a scannable card which stores a plurality of network configuration parameters. The network configuration parameters are scanned into an input device of the network device to communicate to the host computer, thereby making the network device ready to initiate communications between the network device and the host computer.

### CROSS-REFERENCE TO RELATED APPLICATION(S)

None.

### BACKGROUND OF THE INVENTION

The present invention relates to a method and apparatus for initializing equipment that functions as a node in a communications network. More particularly, the present invention relates to a method and apparatus for configuring a network device to communicate in a communications network using a scannable network configuration token.

As the internet and real-time connectivity become key tools for commerce, large networks are being established. If the network is part of a geographically diverse enterprise, the network is not only large but has many remote locations. While the general population is becoming more familiar with computer equipment installation and equipment makers have made installation and start-up more simple, proper installation and set-up of equipment, including its network communication capabilities, may require that trained personnel attend to each such location. Alternatively, there can be greater investment in equipment preparation before equipment is sent to the location. However, the latter requires that the equipment be shipped first from the supplier to the preparation technician location and, after preparation, shipped to the ultimate installation location. For a large, geographically dispersed network, such additional steps can add many increments of additional cost and logistical difficulty.

An example is a networked system of sites for performing transactions, such as money transfers or issuing money orders. Expansion of the number and geographical spread of participating transaction sites is desirable. Where a party handling payment services operations teams with a partner business that has a large number of retail or other suitable transaction sites, a large number of transaction terminals or personal computers (PC's) may need to be installed or enhanced with transaction capability in a short period of time. This new or enhanced equipment generally makes use of the existing network facilities of the partner business, as well as connecting to a secure network of the payment services operations computers. Thus, installation and set-up tasks often involve network configuration parameters from more than one network, i.e., an intermediate network as well as an ultimate destination network. Once the proper information is assembled for network configuration of the equipment, its efficient and totally accurate deployment to individual sites is important.

In the past, the assembled network information has been compiled on large spreadsheets. Technicians or trainers are sent out with the spreadsheets to perform installation at individual locations. However, the difficulty of correctly finding and accurately entering the spreadsheet information has caused an undesirable level of errors. Even assuming possession of accurate information, the technicians or trainers must be familiar with the configuration procedures for the new network devices. Error correction is difficult and costly.

U.S. Pat. No. 6,385,648 covers methods for initializing an uninitialized box (e.g., computer, workstation, server, etc.) in a data communications network. The patent discusses the need to initialize a box when it is added to a network. It notes that this can sometimes be done manually at a back panel. In the invention, the IP address, subnet mask and default gateway are remotely initialized by a configuration utility. The configuration utility appears to be used to communicate the settings for the new box to the box, once the box has responded to a broadcast service announcement seeking uninitialized boxes.

Security issues are raised when a secure network is expanded. In Windows, network configuration must be done in an “administrator” mode not usually made available to users. For terminals that do not run Windows, configuration is usually possible only in some password-PIN protected mode. Thus, it is preferable or necessary that network configuration be done in a mode where the opportunity for entering data is restricted and the mode is used for only the necessary steps of the configuration function.

Cards and other tokens from which information can be read are used in a number of applications. Credit cards are scanned in connection with retail purchases. Access control cards are used to offer scannable identification tokens to door or gate access points at buildings and parking lots. Scannable tokens are used to specify the contents of a package of money order forms to be loaded into a computer-supervised printer (U.S. Pat. No. 5,377,271). Scannable cards are also used to authenticate a computer user. U.S. Pat. No. 6,081,900 involves secure network access. One aspect of the patent is how a user authenticates himself/herself to the network. Among the means mentioned is the use of a magnetic card reader. Scannable cards are also used to cause a particular user's configuration to be loaded on a computer. U.S. Pat. No. 5,848,231 allows a computer to be configured in a number of ways based on what a user presents and how the user identifies himself/herself. One suggested method of identifying a user is a magnetic card. In this patent, the configuration involves screen resolution, available peripherals, keyboard layout, mouse speed, file permissions and other similar user interface parameters.

Even the most robust systems can have problems, due to power outages, operator error and other causes. If problems arise with network equipment after installation, various parts of the installation may need to be repeated. If skilled personnel must be dispatched to the location, there is both expense and delay. If the location is an important source of transactions, there is both inconvenience and likely loss of revenue during the downtime. Rapid and efficient restoration of the equipment to full functioning in the network is essential.

There is a need in the art for a more efficient way to configure the communication parameters of equipment or nodes that are being added to a communications network.

### BRIEF SUMMARY OF THE INVENTION

The present invention provides a method and apparatus for enabling a network device to communicate in a communications network using a scannable network configuration token. The present invention provides an efficient way to configure equipment or nodes into a communications network.

In one embodiment of the present invention, a method for enabling a network device to communicate to a host computer in a communications network comprises the steps of:

providing a scannable token storing a plurality of network configuration parameters;

providing the network device with an input port for scanning the plurality of network configuration parameters into the network device;

receiving at the network device via the input port the plurality of network configuration parameters; and

storing in memory accessible to the network device those network configuration parameters necessary for the network device to communicate to the host computer.

In one embodiment of the present invention, an apparatus for enabling a network device to communicate to a host computer in a communications network comprises:

a scannable token which stores a plurality of network configuration parameters;

an input device associated with the network device for scanning the plurality of network configuration parameters; and

a network configuration program running at the network device and responsive to scanning of the scannable token for storing the plurality of network configuration parameters to make the network device ready to initiate communications between the network device and the host computer.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a schematic block diagram of one embodiment of a communications network wherein one or more network devices are enabled to establish communication with a host computer by using a scannable network configuration token, in accordance with the principles of the present invention.

FIG. 2 is a schematic block diagram of another embodiment of a communications network wherein one or more network devices used for transactions are enabled to establish communication with a transaction-processing host computer by using a scannable network configuration token, in accordance with the principles of the present invention.

FIG. 3 is a schematic block diagram of an exemplary financial transactions communications network wherein a store terminal is configured to establish communication with a host computer of a financial transactions organization by using a scannable card with a plurality of network configuration parameters, in accordance with the principles of the present invention.

FIG. 4 is a front plan view of one embodiment of a scannable network configuration card, in accordance with the principles of the present invention.

FIG. 5 is a back plan view of one embodiment of a scannable network configuration card, in accordance with the principles of the present invention.

FIG. 6 is a flow chart showing the steps for receiving scanned configuration information from a token and using it to configure, and, optionally, to confirm operation of, communication with a predefined host computer before initiating a transactional communication with the predefined host computer.

### DETAILED DESCRIPTION

In the following description of preferred embodiments, reference is made to the accompanying drawings, which form a part hereof, and in which is shown by way of illustration a specific embodiment in which the invention may be practiced. It is to be understood that other embodiments may be utilized and structural changes may be made without departing from the scope of the present invention.

For purposes of explanation, numerous specific details are set forth in the following description in order to provide a thorough understanding of the present invention. However, it will be evident to one of ordinary skill in the art that the present invention may be practiced without some of these specific details.

While this invention is susceptible of embodiment in many different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated.

The innovative teachings of the present application will be described with particular reference to the presently preferred embodiments, wherein these innovative teachings are advantageously applied to the particular problems of installation of a network device, terminal or node to efficiently establish communication with a host computer of a communications network. However, it should be understood that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality.

The following terms are used throughout the description, but their description in any embodiment should not be considered as limiting the scope of the invention.

Network

The present invention is particularly suitable for establishing communication in a communications network between a store, PC or transaction terminal and a host computer of a transactions handling organization via an intermediate headquarters gateway system. It will be appreciated that the communications network can be any network (or network of networks) for which parties care about access and authorization to do financial or other transactions. In one embodiment, it is a network of nodes at which money order and/or money transfer transactions can be initiated, confirmed and executed. The network is formed by configuring new equipment into the existing network of a partner business and linking that intermediate network to a financial transaction organization's host computer.

Scannable Card or Token

One skilled in the art will readily realize that the present invention is not limited in scope to a particular scannable card or token. The scannable card or token can be a magnetic card or an intelligent chip card or other scannable token capable of storing network configuration information thereon. The card or token will be present at initial installation but may also remain at the equipment location to be used when restoration of the equipment is needed.

Network Configuration Software

Network configuration software can be any suitable software that takes and/or responds to input, such as a plurality of network configuration parameters, from an input device or a scanner associated with a network device. The software may run format and/or edit screens on the input to make sure it is the expected configuration data. If proper configuration data is received from the card or token, this program stores the data, either temporarily or in non-volatile memory, where it is accessible for initiating communications, such as a transactional or financial transactional communication, with a predefined host computer. The software may optionally prepare an outgoing initial message using the configuration parameters for testing. This message may be sent immediately or at a later time. In an optional test, when the software sends a communication to the predefined host computer and receives at the network device a successful or failed return communication from the host computer (or network), it confirms that communication between the network device and the host computer has or has not been successfully established.

Network Configuration Parameters

Network configuration parameters can be any type of suitable network configuration parameters, which, for TCP/IP networks, may include an address of a predefined host computer, an address of a network device, and a gateway network address. Alternatively, the configuration parameters may indicate where address information may be found, such as via Dynamic Host Configuration Protocol (DHCP). The network may use landlines or wireless channels (e.g., Wi-Fi) and may use protocols other than TCP/IP, which have different addressing schemes, such as IPX/SPX, Ipv4, Ipv6, RSVP or RTP and other future network protocols for fixed or mobile nodes. Also, in the case of a dial-up type network, the “address” information provided could be a telephone access number to be used by the network device.

Network Overview

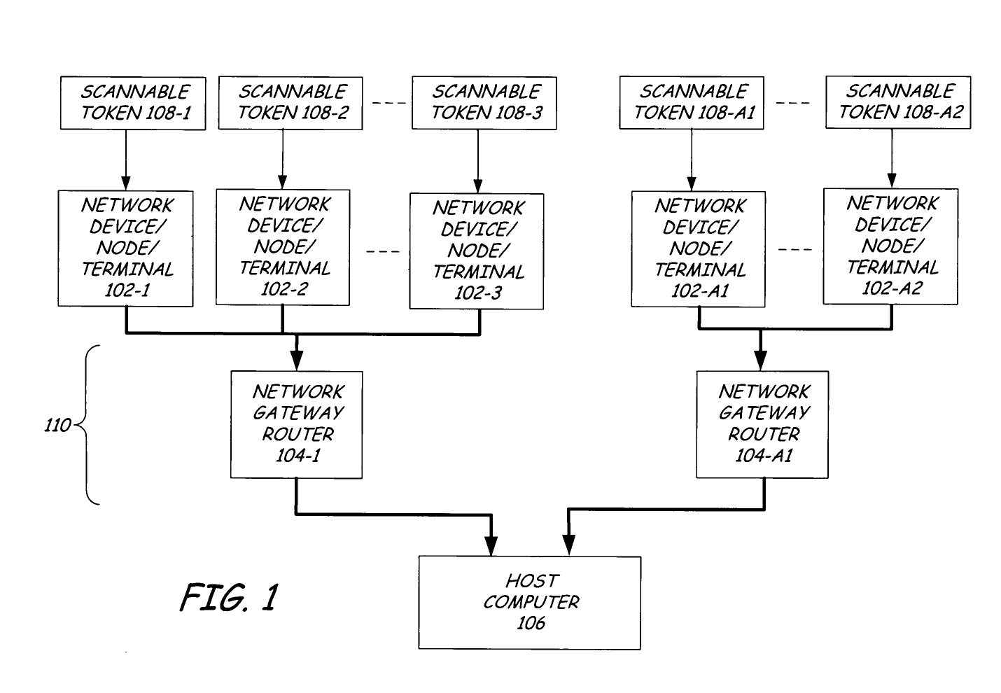

In FIG. 1, one embodiment of a communications network 100 is illustrated, wherein a plurality of network devices 102, such as 102-1, 102-2, . . . 102-N, at remote sites, are connected to an intermediate network's gateway/router 104, such as 104-1. The intermediate network 110 may be a corporate network or other organization's internal network that serves terminals at multiple sites of a business entity or group. The network gateway router 104-1 is capable of network communication with an external predefined host computer 106, for example, a predefined host computer of a transactions processing organization that wishes to use the network devices as agent terminals that participate in transactions processed at the host computer 106. The network configuration parameters will typically be unique for each network device, but in some networks the same parameters may be suitable for configuring two or more devices.

In the present invention, a set of network configuration parameters for a remote site are stored on a scannable card or token 108. Each device 102-1, 102-2, . . . 102-N has an associated card 108-1, 108-2, . . . 108-N. The token 108 is scanned at a network device 102, whereby the network configuration parameters on the card are captured for use to establish communication between the network device 102 and the external predefined host computer 106.

Also in FIG. 1, another group of network devices 102 at remote sites, such as 102-A1, . . . 102-AN, are connected to another intermediate network's gateway/router 104, such as 104-A. The network gateway router 104-A1 is capable of network communication with the external predefined host computer 106.

It will be appreciated by a person skilled in the art that any number of network devices 102 can be initialized by network configuration parameters or information stored on an associated scannable token 108 to establish communication with the external predefined host computer 106. Also, it will be appreciated by a person skilled in the art that any number of intermediate networks 110, i.e., the network linking a group of network devices 102 and a computer system where the network gateway/router 104 resides, can be implemented to communicate to the external predefined host computer 106. Further, it will be understood that the networks may be public, such as the Internet, or private, using dedicated lines. Furthermore, it will be appreciated that depending on how the terms “external” or “internal” are defined in a network environment, an external host computer can be a computer within a network but external to a particular network device or a particular sub-network.

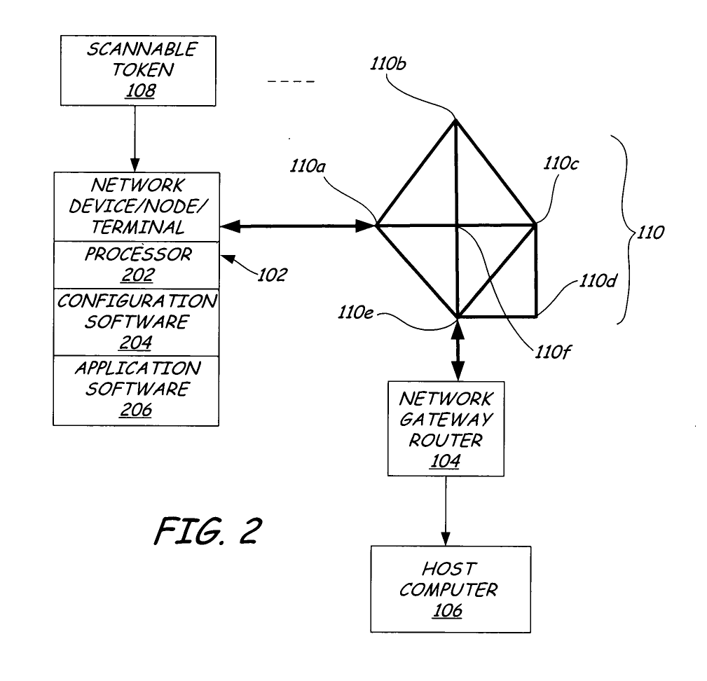

FIG. 2 illustrates that a network device 102 can be configured as one network node of the intermediate network 110 (with many network nodes 110a-110e), which, in turn, communicates with host computer 106 via the network gateway router 104. The intermediate network 110 may include a plurality of network nodes in any connection configuration. The network nodes may communicate among each other as shown in FIG. 2, communicate to one single center node 110f, or be implemented in any other suitable way, using TCP/IP or any other suitable communication protocols with node addressing.

The network device 102 has a processor 202 on which executes software, including network configuration software 204 that controls reading and use of the network configuration parameters stored on the scannable token 108. In addition, there is application software 206 executing on processor 202, which may be used for transactions processing or other applications where it is necessary or desirable to establish communication with the host computer 106. That is, the application software 206 will make use of the network communication functions that are enabled by the network configuration operation that the present invention facilitates.

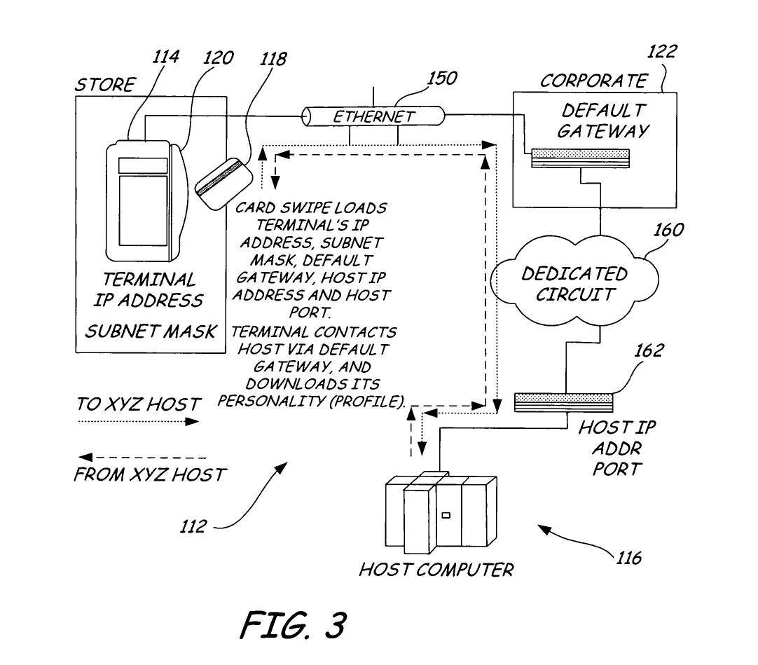

FIG. 3 illustrates an exemplary simplified communications network 112 wherein a store terminal 114 with a transaction application is to be configured to establish it as a network device in communication with a host computer 116 of a financial transaction processing organization. This configuration is simplified by using a scannable card 118 containing the plurality of necessary network configuration parameters, some of which are shown as they might (optionally) be printed on the front of the card 118 (see the top of FIG. 3). The transaction application requires an exchange of data with the host computer 116. Thus, to become “transaction ready,” the terminal must be configured for communication with host computer 116.

In this example a TCP/IP protocol is used for communication. Thus, the network configuration parameters may include a terminal IP address, a subnet mask address, a default gateway address, a host computer IP address, and a host computer port address. Although a variety of wired or wireless communication channels may be present to connect the terminal 114 and host computer 116, as shown in FIG. 3, an Ethernet channel 150 interconnects the terminal 114 and the default gateway 122, while a dedicated circuit 160 and host router 162 interconnect the default gateway 122 and the host computer 116.

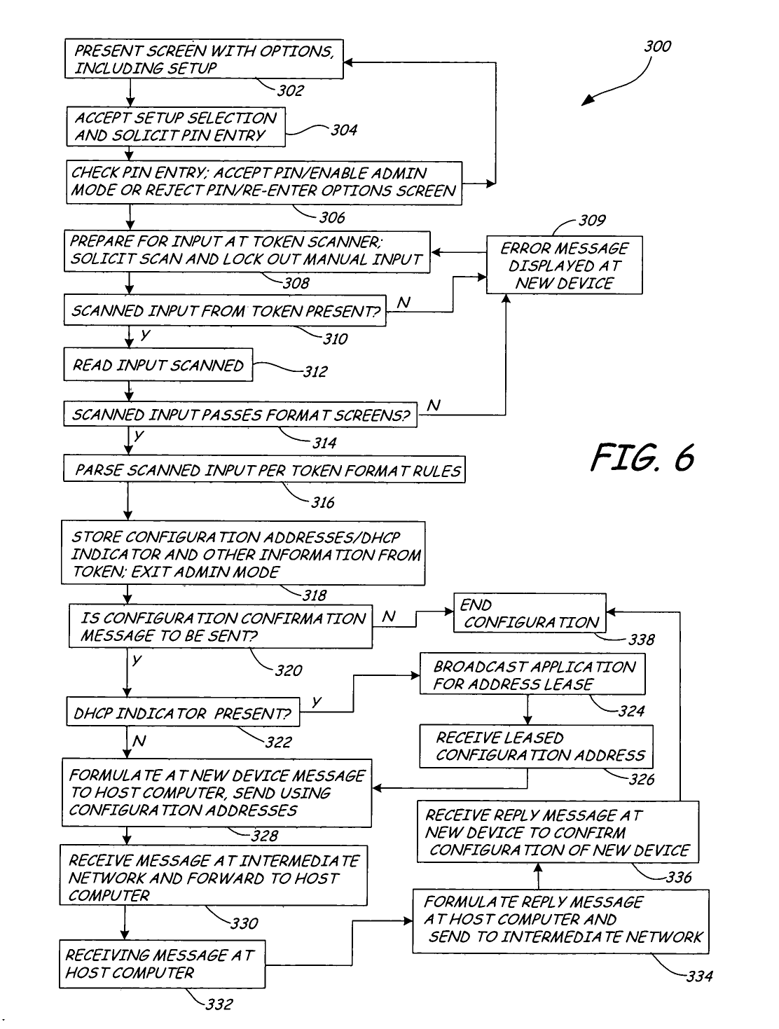

As shown in FIG. 3, the network configuration parameters stored on the card 118 are scanned in an input device 120 associated with the network device or terminal 114. This is preferably a card swipe device as commonly used for credit cards, but may be any available device for reading a card or other token with stored, readable information or for downloading information stored on or in the card. Thus, scanning is not limited to conventional magnetic or optical reading proximity methods but may encompass other forms of reading or receiving transmission of card-stored data. The device delivers the data obtained from the card as scanned input to an appropriate input port. As will be described in greater detail below in connection with FIG. 6, the configuration process is controlled by the terminal's network configuration software. After receiving the network configuration parameters, the terminal 114 stores these in appropriate parameter locations in memory. In some embodiments, the configuration process ends here; the parameters are implemented and the terminal is “transaction ready.” That is, the transaction application can now send TCP/IP messages to the host computer 116. In other embodiments, an exchange of messages using the newly installed network configuration parameters will occur. This exchange can confirm that network communications are operational. It can also be used to send down from the host computer 116 to the terminal 114 profile or personality information. For example, the terminal 114 could be provided with hours of operation, transaction limits or names associated with the terminal. In addition, a secondary set of configuration data might be provided as part of the download from the host computer to facilitate an alternate addressing path, in case the path defined by the primary configuration data is not available.

In still other embodiments, the storage of configuration parameters may be for scanning testing only. Here the parameters may be stored and then those useful in a scan test displayed, e.g., to confirm that a scanning function works and/or the card has readable data. The scanned data may be proofread or machine-checked for content or logged in a test file, but in such a test scan the scanned data are not implemented as the terminal's actual configuration parameters.

If the configuration process is to include an initial message exchange, the terminal 114 initiates a communication to a corporate default gateway 122 in the intermediate network, using a network communication program resident at the terminal 114. The default gateway 122 passes this communication from the default gateway 122 to the host computer 116. The host computer 1,16 then sends a return communication to the corporate default gateway 122 for forwarding to the terminal 114. A successful return communication ensures completion of the installation and initialization required for network configuration of the terminal 114.

Configuration Token

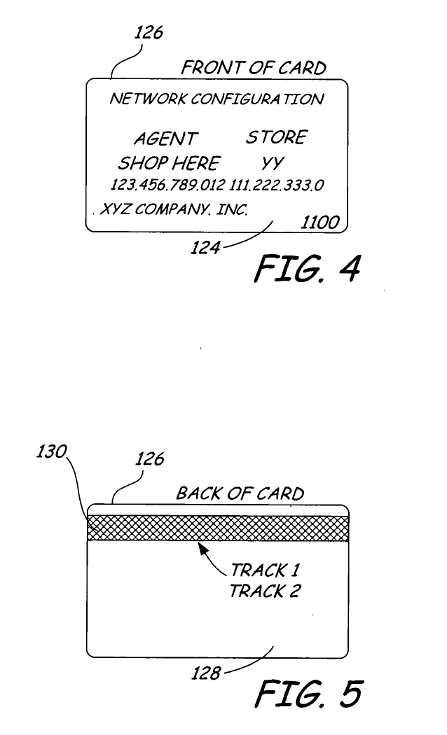

The information required to configure terminal 114 as a node capable of communicating to host computer 116 is established by the network managers and stored on scannable configuration token 118, which may be a card with magnetic or optical or other comparable storage. FIG. 4 illustrates a front side 124 of a scannable network configuration card 126, whereas FIG. 5 illustrates a back side 128 of the scannable network configuration card 126. As discussed above, the front side 124 of the card 126 may be embossed or printed with network configuration parameters such as a terminal IP address, etc. On the back side 128 of the card 126, a magnetic strip 130 may include one or more tracks for storing corresponding and/or additional network configuration parameters in scannable, electronic form.

One exemplary scannable network configuration card 126 is an agent network configuration load card. The card enables an agent or other non-technical person to easily configure TCP/IP settings for an agent terminal running a money transfer or money order transaction product at a specific agent location. The settings specified by an agent network configuration card may include a TCP/IP address, subnet mask, and default gateway, etc. The detailed specifications of the card may include the following:

1. Card Physical Characteristics:

A. Dimensions: 3.375″ (L)×2.125″ (W)×0.030″ thick (H)

B. Distance from top of card to magnetic stripe: 0.223″

2. Magnetic Stripe Characteristics:

A. Track 1: 210 BPI Density, 7 bits/character (including parity bit)

B. Track 2: 75 BPI Density, 5 bits/character (including parity bit)

C. Individual track width: 0.110″

3. Data Format:

A. Information is recorded on a magnetic stripe on the back of the card, using a 2-track format.

1). Track 1 contains 70 bytes of data plus overhead, total=79.

2). Track 2 contains no data.

3). Overhead is equal to the number of fields on a track plus 1.

B. Field lengths (Track 1 only): (These may be defined in any order
and in varying lengths; the following is only an example.)

| Field | Field Length |
|---|---|
| Card type | x bytes (e.g., 1 to 99) numerically identifies |
| | card type |
| Agent store number | y bytes (e.g., 1 to 99999) |
| Transaction Host IP address | a bytes |
| Transaction Host Port | b bytes (e.g., 1 to 65536) |
| Terminal's TCP/IP address | a bytes (zero filled if using DHCP) |
| Terminal's Subnet mask | a bytes (zero filled if using DHCP) |
| Default gateway | a bytes (zero filled if using DHCP) |
| Flag Field | c bytes (e.g. 0 to 9) numerically indicates |
| | an action that should be taken after a card |
| | is scanned |
| Card type description | z bytes, e.g., “AAABBBCCCC” |

DHCP refers to Dynamic Host Configuration Protocol, a facility whereby dynamic or temporary IP addresses are assigned (“leased”) to network nodes to make it unnecessary for each node to have its own static IP address.

C. Track lengths:

Track 1 data can have up to 79 characters.

Track 2 data can have up to 40 characters (low density).

D. Control characters:

%—Track 1 indicator

\hat{ }—Field Separator track 1 data

=—Field Separator track 2 data

;—Track 2 indicator

?—End Encoding

E. Card type:

This 2-digit field identifies the card type. This is a host-assigned number to identify this particular type of card product. (The number “xx” will be used as an example.

F. Track contents:

1) Track 1 (fs is ‘\hat{ }’)

Track 1 indicator (%), Card type, fs, Agent store number, fs, Transaction Host IP address, fs, Transaction Host Port, fs, Terminal TCP/IP address, fs, Terminal Subnet mask, fs, Default gateway, fs, Flag Field, fs, Card type description, End Encoding

2) Example “Notepad” display of card scan:
Track 1:
% xx\hat{ }yy\hat{ }aaaaaaa\hat{ }bbbbbb\hat{ }aaaaaaa\hat{ }aaaaaa\hat{ }aaaaaa\hat{ }c\hat{ }AAAABBBCCCC?

| | | | Card | | | |
|---|---|---|---|---|---|---|
| | | | Type | | | |
| Agent | Store | Flag | Des- | TCP/IP | Subnet | Sequence |
| Name | Number | Field | cription | Address | Mask | |
| This | This | This | This | This is | This is | This |
| identi- | identi- | indicates | pro- | the | the agent- | uniquely |
| fies the | fies the | an action | vides a | agent- | assigned | identifies |
| agent. | agent's | that | text | as- | subnet | the data |
| | store | should be | descrip- | signed | mask for | on the |
| | number. | taken | tion of | TCP/IP | this IP | card |
| | | after a | the card | address | address. | |
| | | card is | type. | for this | | |
| | | scanned. | | termi- | | |
| | | | | nal. | | |

Notes:

If agent store number yy is using DHCP, but it has provided the host computer with a NAT'd (network address translated) host IP address of a1.a2.a3.a4 using port b, Track 1 would look like this

%xx\hat{ }yy\hat{ }a1.a2.a3.a4\hat{ }bbbbbb\hat{ }000000\hat{ }000000\hat{ }000000\hat{ }c\hat{ }AAABBBCCCC?

The Flag field may be used to indicate to a terminal/device software what action should be taken after a card is scanned. For example, the action can be: 1) attempt to immediately connect a terminal/device to the host computer and confirm messages can be sent/received; 2) just store configuration information from the card onto a terminal/device without immediately connecting the terminal/device to the host computer; or 3) perform a test scan by storing scanned data for display of data contents (e.g. network configuration parameters) on the terminal/device, without storing in that portion of the memory of the terminal/device from which actual configuration parameters will be taken for network messages.

After the track identifier (% or ;) but before the field separator (\hat{ } or =) there is a number. This number identifies the card type. At present, card type “xx” refers to a network configuration load card, with the above field definitions. Other type codes may identify other card types with other field definitions.

The number printed on the lower right-hand corner of the load card is referred to as the sequence number. The factory that created the card provides this number. It uniquely identifies this particular load card and associated data (Agent store number, Terminal TCP/IP address, Subnet mask, Default gateway, etc.).

4. Load Card Identification:

A. The front of each load card may contain the following printed information:

1. The words “Network Configuration Card for ABC Terminal”

2. The words “Agent Name” “Store” “Terminal”

3. The Agent name, store #, and terminal #.

4. The Terminal TCP/IP address, and subnet mask of the terminal.

5. The words “XYZ COMPANY, INC.”

6. The sequence number (lower right hand corner).

With additional available storage, e.g., on track 2 or track 3 of a card, further configuration information may be provided. For example, a secondary set of configuration data might be provided to facilitate an alternate addressing path, in case the path defined by the primary configuration data is not available after a number of tries.

Software Implementation

Capture and implementation of the network configuration information obtained from a scannable token 118 is under the control of network configuration software running at terminal 114. FIG. 6 is a flow chart showing the method 300 by which the software at terminal 114 (assumed not to be a PC) handles the scanned configuration information and the resulting (optional) initial message exchange.

When the new, to-be-configured terminal or other network device 114 is turned on, at step 302 a screen with a set of options is presented, such as in the form of buttons on a touch screen. One button permits the selection of Set-up. At step 304, the selection of Set-up is accepted and, because an administrator mode will be entered, the user is solicited to provide a PIN in an input box. At step 306, the entered PIN is checked. If the PIN is accepted, the administrator mode is entered; if the PIN is rejected, then the Options screen is re-entered. At step 308, the software prepares to take input from the token scanning device 120. The screen display solicits token scanning and, as part of entering the administrator mode, may restrict input to the scanning device. This ensures that only the desired configuration data is entered, i.e., any manual input from the keyboard is locked out or inhibited. At step 310 the software at the terminal 114 determines whether any scanned input from a token is present. For many systems the token scanner 120 provides input to the terminal 114 that appears to have been keyboard-entered, so the computer automatically checks for such data. If there is no scanned input present, then the software returns to the state in which it prepares to receive input 308 and at step 309 an error message is displayed. If scanned input is present at step 312, responsive to the input, the software reads it. At step 314 the software determines whether the scanned input passes the various format requirements or screening steps. If the scanned input fails the format tests, then at step 309 an error message is displayed. This indicates that the configuration information is incorrect and configuration cannot proceed.

If the scanned input is in the proper format, at step 316, the input is parsed in accordance with the format rules defined for the token that provided the input. That is, the various pieces of data are interpreted according to the field definitions so that the IP address, subnet mask, default gateway, host IP address port and host data are placed in the proper storage fields within the memory. Here, the card type may be utilized to indicate different card types with different format rules or field definitions, for different networks. At step 318 the configuration addresses or, alternatively, if the token provides a DHCP indicator, data such as all zeros in the fields where the terminals TCP/IP address, subnet mask, and default gateway would normally be specified as mentioned above, are stored. With this accomplished, the administrator mode can be exited, and the restriction on the input mode imposed by the software controlling configuration is removed.

At step 320, the software determines whether an initial, configuration confirmation message is to be sent. This can be a parameter built into the software for a particular terminal, or it can be a piece of data determined from the scanned token, such as from the card type or terminal or from the Flag Field. If no initial, configuration confirmation message is to be sent, then the configuration sequence ends. If the Flag Field is checked and indicates that a test scan only is to be performed, a test results screen can be displayed or printed, showing what data has been read and whether any data defects were detected. After this output, the configuration sequence ends.

If, on the other hand, an initial, configuration confirmation message is to be sent, then at step 322, the software checks for a DHCP Indicator. If present, at step 324, the broadcast to find the DHCP server and apply for a leased configuration address occurs. Once this address is received at step 326, the software returns to step 328 where the configuration address (either from the scanned token or from the DHCP server) is used to formulate and send a message directed to the host computer.

At step 330 the message from the new terminal 114 is received at the intermediate network, which may be a default gateway 122, as shown in FIG. 3. The intermediate network forwards this message on to the host computer 116. In step 332, the message is received at the host computer 116. To complete and confirm the configuration, at step 334 the host computer 116 formulates a reply message to the new terminal 114 and sends that message to the intermediate network, i.e., default gateway 122, in accordance with the addressing information provided to the host computer 116. At step 336, the new terminal receives a reply message from the host, which confirms configuration of the new device as a node that can communicate to the host computer 116. At this point the configuration process ends, it having been proved that messages necessary to initiate a transaction or to receive a transaction can be sent back and forth between the new terminal 114 and the host computer 116.

If desired, the terminal 114 can be programmed to log all the attempts to receive scanned information and perform configuration. When the first message is sent successfully to the host, it can include the log of information on attempts to perform configuration, including data scanned when an incorrect or defective card was scanned. This log can be analyzed at the host terminal by machine and/or human agents, e.g., to diagnose certain problems in the configuration process and/or report on the configuration status or problem causes.

If a PC running Windows were the equipment to be configured, then the above steps would be executed using custom software to display pull down windows providing prompts for selecting the scanned configuration data input and storing it in the designated fields. Depending on the version of Windows, once the information captured by the custom software is in memory, a restart may be necessary before the configuration is completed.

It will be seen that if a problem causes configuration data to be lost or become corrupted, the configuration process as shown in FIG. 6 can be repeated by rescanning the card used for original configuration. This makes it unnecessary to send information or a service person to the equipment location and thus permits rapid, accurate restoration of the equipment to transaction-ready status

It will be appreciated to the person skilled in the art that other types of network configuration load cards can be used and that the physical characteristics, materials, and contents of the cards can be varied within the scope of the present invention. Also, it will be appreciated to the person skilled in the art that a smart card configured with an intelligent chip therein, or the like, may be used without departing from the principles of the present invention.

What is claimed is:

1. A method for enabling a network device to communicate to a host computer in a communications network, comprising the steps of:
providing a scannable token storing a plurality of network configuration parameters;
providing the network device with an input for scanning the plurality of network configuration parameters into the network device;
receiving at the network device as scanned input the plurality of network configuration parameters; and
storing in memory accessible to the network device those network configuration parameters necessary for the network device to communicate to the host computer.

2. A method as recited in claim 1 wherein the step of storing in memory accessible to the network device comprises storing in memory and implementing those network configuration parameters that make the network device ready to initiate transaction communications between the network device and the host computer.

3. A method as recited in claim 1 wherein the step of storing in memory accessible to the network device comprises storing in memory those network configuration parameters that are useful for a test scan without making the network device ready to initiate transaction communications between the network device and the host computer.

4. A method as recited in claim 1 wherein the network device is part of an intermediate network and the step of storing network configuration parameters includes storing:
host computer address data; and
intermediate network address data.

5. A method as recited in claim 1 wherein the step of storing network configuration parameters includes storing: Transaction Host IP address, Transaction Host Port, network device IP address, network device subnet mask, and network device default gateway.

6. A method as recited in claim 1 wherein the step of storing network configuration parameters includes storing: Transaction Host IP address, Transaction Host Port and DHCP enabling data.

7. A method as recited in claim 2 further comprising using the plurality of network configuration parameters to initiate an initial message exchange with the host computer to confirm configuration.

8. A method as recited in claim 2 further comprising using the plurality of network configuration parameters to initiate an initial message exchange with the host computer to download profile data to the network device.

9. A method as recited in claim 2 further comprising entering an administrator mode to perform the step of storing in memory accessible to the network device the network configuration parameters and using a PIN to control access to the administrator mode.

10. A method as recited in claim 1 further comprising entering an administrator mode to perform the step of storing in memory accessible to the network device and while in the administrator mode restricting input to the scanned input.

11. A method as recited in claim 2, further comprising storing at the network device a log of attempts to configure the network device and transmitting that log to the host computer for analysis.

12. A method as recited in claim 2, further comprising performing at the host computer a analysis of the log of attempts to configure the network device.

13. An apparatus for enabling a network device to communicate to a host computer in a communications network, comprising:
a scannable token that stores a plurality of network configuration parameters;
an input device associated with the network device for scanning the token to detect the plurality of network configuration parameters for transfer to the network device; and
a network configuration program executable at the network device and responsive to scanning of the scannable token for storing the plurality of network configuration parameters to make the network device ready to initiate communications between the network device and the host computer.

14. An apparatus as recited in claim 13, wherein the network device is part of an intermediate network and the network configuration program stores network parameters comprising:
host computer address data; and
intermediate network address data.

15. An apparatus as recited in claim 13, wherein the network configuration program stores network configuration parameters comprising: Transaction Host IP address, Transaction Host Port, network device IP address, network device subnet mask, and network device default gateway.

16. An apparatus as recited in claim 13, wherein the network configuration program stores network configuration parameters comprising: Transaction Host IP address, Transaction Host Port, and DHCP enabling data.

17. An apparatus as recited in claim 13, wherein the network configuration program further comprises instructions for initiating an initial message exchange with the host computer to confirm configuration.

18. An apparatus as recited in claim 13, wherein the network configuration program further comprises instructions for initiating an initial message exchange with the host computer to download profile data to the network device.

19. An apparatus as recited in claim 13, wherein the network configuration program further comprises instructions for entering an administrator mode to perform the step of storing in memory accessible to the network device the network configuration parameters and using a PIN to control access to the administrator mode.

20. An apparatus as recited in claim 13, wherein the network configuration program further comprises instructions for entering an administrator mode to perform the step of storing in memory accessible to the network device and while in the administrator mode restricting input to the input device for scanning.

21. An apparatus as recited in claim 13, wherein the network configuration program further comprises instructions for storing at the network device a log of attempts to configure the network device and transmitting that log to the host computer for analysis.

22. An apparatus as recited in claim 13, wherein the host computer further comprises instructions for performing at the host computer a analysis of the log of attempts to configure the network device.

23. A computer readable storage medium storing instructions that, when executed by a processor of a network device cause the network device to perform a method of controlling network configuration of the network device to communicate with a host computer, comprising:
activating at the network device an input device for scanning a scannable token storing a plurality of network configuration parameters;
receiving at the network device as scanned input the plurality of network configuration parameters; and
storing in memory accessible to the network device those network configuration parameters necessary for the network device to communicate to the host computer, thereby making the network device ready to initiate communications between the network device and the host computer.

24. A computer readable storage medium as recited in claim 23 wherein the network device is part of an intermediate network and the step of storing network configuration parameters includes storing:
host computer address data; and
intermediate network address data.

25. A computer readable storage medium as recited in claim 23 wherein the step of storing network configuration parameters includes storing: Transaction Host IP address, Transaction Host Port, network device IP address, network device subnet mask, and network device default gateway.

26. A computer readable storage medium as recited in claim 23 wherein the step of storing network configuration parameters includes storing: Transaction Host IP address, Transaction Host Port and DHCP enabling data.

27. A computer readable storage medium as recited in claim 23 further comprising instructions that, when executed by a processor of the network device cause the network device to perform a method of controlling network configuration of the network device to communicate with a host computer, further comprising using the plurality of network configuration parameters to initiate an initial message exchange with the host computer to confirm configuration.

28. A computer readable storage medium as recited in claim 23 further comprising instructions that, when executed by a processor of the network device cause the network device to perform a method of controlling network configuration of the network device to communicate with a host computer, further comprising using the plurality of network configuration parameters to initiate an initial message exchange with the host computer to download profile data to the network device.

29. A computer readable storage medium as recited in claim 23 further comprising instructions that, when executed by a processor of the network device cause the network device to enter an administrator mode to perform the step of storing in memory accessible to the network device those network configuration parameters and use a PIN to control access to the administrator mode.

30. A computer readable storage medium as recited in claim 23 further comprising instructions that, when executed by a processor of the network device cause the network device to enter an administrator mode to perform the step of storing in memory accessible to the network device and while in the administrator mode to restrict input to the scanned input.

31. A computer readable storage medium as recited in claim 23 further comprising instructions that, when executed by a processor of the network device cause the network device to store a log of attempts to configure the network device and to transmit that log to the host computer for analysis.

32. A computer readable storage medium as recited in claim 23 further comprising instructions that, when executed by a processor of the host computer causing a analysis of the log of attempts to configure the network device.
